(19) United States
(12) Patent Application Publication
(10) Pub. No.: US 2009/0095716 A1
(43) Pub. Date: Apr. 16, 2009

(54) Circuit Breaker

(75) Inventor: Jurgen Einschenk, Panketal (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/300,941

(22) PCT Filed: May 11, 2007
(86) PCT No.: PCT/EP07/54596

§ 371 Date: Nov. 14, 2008

(30) Foreign Application Priority Data
May 16, 2006 (DE) 10 2006 023 372.7

(51) Int. Cl. H01H 33/66

(52) U.S. Cl. 218/10

(57) ABSTRACT

A circuit breaker has a nominal current contact arrangement with a nominal current contact and a nominal current mating contact that are movable relative to each other, and with an arc contact arrangement that has an arc contact and an arc mating contact that are movable relative to each other. The circuit breaker also has kinematics driven by an actuating member which is effectively connected with the nominal current contact and the arc contact and configured, as a function of a breaking movement of the actuating member, to effect first a disconnection of the nominal current contact from the nominal current mating contact, before a disconnection of the arc contact from the arc mating contact occurs. The effective kinematics is also designed in such a way that, as a function of the switching-on movement of the actuating member, first an electrical connection of the arc contact is created with the arc mating contact, before an electrical connection of the nominal current contact is made with the nominal current mating contact.

The invention relates to a circuit breaker with a rated current contact arrangement, which has, arranged movably relative to one another, a rated current contact and a rated current mating contact, and with an arcing contact arrangement, which has, arranged movably relative to one another, an arcing contact and an arcing mating contact.

U.S. Pat. No. 4,538,039 has disclosed a circuit breaker which has a rated current contact, in the form of a pin, of a rated current switch and a vacuum interrupter, which is connected in parallel with the rated current switch, as the arcing contact arrangement. The circuit breaker known from U.S. Pat. No. 4,538,039 has kinematics, which are connected to the rated current switch and the vacuum interrupter in such a way that, during breaking operation, first the rated current switch is isolated and thereafter the vacuum interrupter is isolated. During making operation, with this circuit breaker first the rated current switch is closed and thereupon the vacuum interrupter is closed.

The object on which the invention is based is to provide a circuit breaker which is advantageous in comparison with the mentioned prior art.

This object is achieved by a circuit breaker as claimed in claim 1. The dependent claims contain advantageous configurations of the invention.

A circuit breaker according to the invention comprises a rated current contact arrangement, which has, arranged movably relative to one another, a rated current contact and a rated current mating contact, and an arcing contact arrangement, which has, arranged movably relative to one another, an arcing contact and an arcing mating contact. In addition, it comprises kinematics, which are capable of being driven via an actuating element. The kinematics comprise a first lever, which is connected at least indirectly to the actuating element, is mounted rotatably about a switching fulcrum and is connected at least indirectly to the rated current contact for the movement thereof. In addition, it comprises a second lever, which is connected at least indirectly to the actuating element and is mounted rotatably both about a first displaceable fulcrum and about a second displaceable fulcrum. This lever is connected at least indirectly in the region of the first fulcrum to the arcing contact for the movement thereof by means of a displacement of the first fulcrum. In the region of the second fulcrum, the second lever acts on a spring element in the event of a displacement. The spring element is configured in such a way that it counteracts a displacement of the second fulcrum with a predetermined force, which is greater than the force which needs to be applied in order to displace the first fulcrum until contact is produced between the arcing contact and the arcing mating contact. In the circuit breaker according to the invention, the arcing contact arrangement can in particular be in the form of a vacuum contact with a switching pole as the arcing contact and a mating pole as the arcing mating contact.

In the circuit breaker according to the invention, the kinematics make it possible for first isolation of the rated current contact from the rated current mating contact to take place as a function of a breaking movement of the actuating element before isolation of the arcing contact from the arcing mating contact takes place. At the same time it makes it possible for first an electrical connection between the arcing contact and the arcing mating contact to be produced as a function of a making movement of the actuating element before an electrical connection between the rated current contact and the rated current mating contact is produced. That is to say that, with the aid of the second lever with the first and the second fulcrum and with the aid of the spring element, a movement sequence can be realized in which, in the event of a making movement of the actuating element, first both the arcing contact and the rated current contact experience a linear movement. Once the arcing contact has covered an excursion path which leads to contact-making, the resistance to a further movement of the arcing contact in the same direction increases. If the spring element is prestressed in such a way that the spring force which counteracts a displacement of the second fulcrum is less than the resistance to a further movement of the arcing contact, a displacement of the second fulcrum counter to the spring force now takes place instead of a further displacement of the first fulcrum. As a result, as the making movement of the actuating element continues, no further linear movement of the arcing contact takes place, but a further linear movement of the rated current contact takes place. If, therefore, the excursion required for closing the arcing contact is designed to be smaller than the excursion required for closing the rated current contact, the arcing contact closes before the rated current contact during a making operation. During a breaking movement of the actuating element, the movement sequence is the reverse, with the result that the rated current contact is isolated before the arcing contact. For this purpose, the first lever may be part of a first lever train and the second lever may be part of a second lever train. The lever trains each comprise the switching fulcrum as a fulcrum and are connected firstly to the actuating element and secondly to the rated current contact or the arcing contact. They are matched to one another in such a way that the excursion of the first lever train is greater than the excursion of the first fulcrum during its displacement.

The arcing contact arrangement can be in the form of a vacuum interrupter with a switching pole as the arcing contact and a mating pole as the arcing mating contact. The switching pole and the mating pole can in this case in particular be in the form of impact contacts, i.e. they have impact faces which hit one another so as to produce an electrical contact and thus counteract a further linear movement of the arcing contact, i.e. of the switching pole, with a very high resistance which is only limited by the mechanical stability of the vacuum interrupter. In addition, as a result of the further tensioning of the spring element, during displacement of the second fulcrum, the switching pressure of the impact faces with respect to one another can be increased, which increases the reliability of the contact. The switching pole and the mating pole of the vacuum interrupter can advantageously contain sintered materials with copper and/or chromium.

The switching sequence in the circuit breaker according to the invention is advantageous in comparison with other switching sequences. During breaking operation, the breaking current commutates from the rated current contact to the arcing contact. Thus, the arc produced when high currents are interrupted runs between the arcing contacts and in the event of the use of a vacuum contact as the arcing contact in the vacuum chamber of the vacuum interrupter. Owing to the material of the arcing contacts, the particular geometry of the arcing contacts and possibly the vacuum, high currents can be connected or interrupted. Melting of the arcing contacts can be counteracted by materials with high melting temperatures. In addition, oxidation and therefore erosion of the contacts is avoided in the vacuum. During making operation, a prearc, i.e. an arc which occurs shortly before the final closure of the contacts, occurs between the arcing contacts where it can be easily managed. In particular when using a vacuum contact as the arcing contact, it can be managed easily in the vacuum interrupter. In the further course of the making movement, the rated current contact then closes and the current commutates from the arcing contact to the rated current contact. Both the arc produced during breaking operation and the prearc are therefore produced between the arcing contacts, where they can be managed easily, in particular when using a vacuum contact.

A compression spring, which is arranged between the second lever in the region of the second fulcrum and an abutment, for example a spring disk, is suitable, for example, as the spring element of the circuit breaker according to the invention. In addition, the circuit breaker can have a spring guide and a spring bearing, which is capable of being displaced with respect to the spring guide and is opposite the abutment and on which the second lever acts in the event of a displacement of the second fulcrum in such a way that tensioning of the spring takes place. If the abutment is configured so as to be capable of being displaced and fixed along the spring guide, as a result of the displacement of the abutment, the excursion for the displacement of the second fulcrum and therefore also the excursion for the switching movement of the arcing contact can be changed.

The circuit breaker according to the invention can be configured in such a way that the actuating element is connected in articulated fashion to the second lever via a lug, with the result that a spring energy stored in the spring element cannot or can only partially have a return effect on the actuating element.

In a variant embodiment of the circuit breaker according to the invention, the rated current contact is shaped at least partially in the form of a hollow cylinder, and the arcing contact is arranged at least partially in particular radially and centrically within the rated current contact, with the result that a switching movement of the rated current contact can take place coaxially with respect to a switching movement of the arcing contact. As a result of this configuration, a movement in the same direction both of the rated current contact and of the arcing contact of the circuit breaker can take place without the two impeding one another. As an alternative to a cylindrical rated current contact, other geometrical shapes of a rated current contact and of a rated current mating contact, which is formed correspondingly to the rated current contact, are also conceivable.

Further features, properties and advantages of the present invention result from the description below relating to an exemplary embodiment with reference to the attached figures.

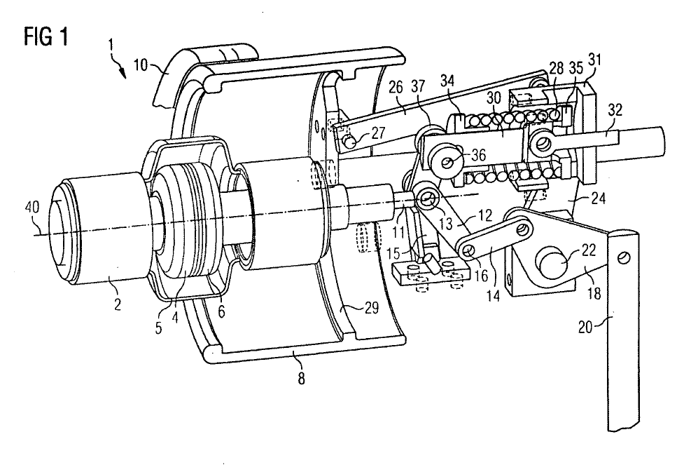

FIG. 1 shows, schematically, an exemplary embodiment of a circuit breaker with a vacuum interrupter and a rated current switch, which is connected electrically in parallel with the vacuum interrupter;

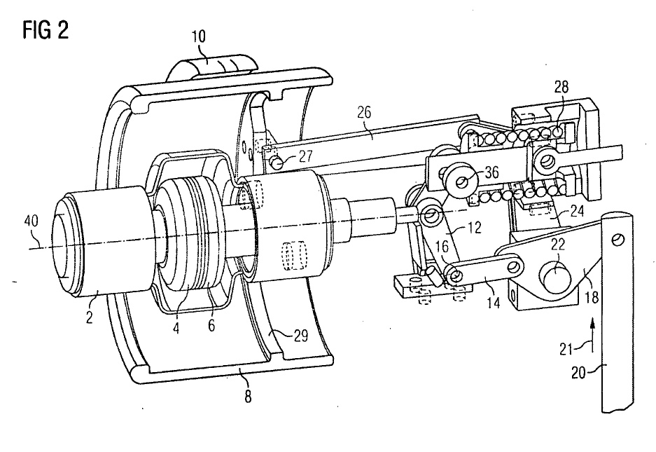

FIG. 2 shows, schematically, the circuit breaker illustrated in FIG. 1 in the closed state;

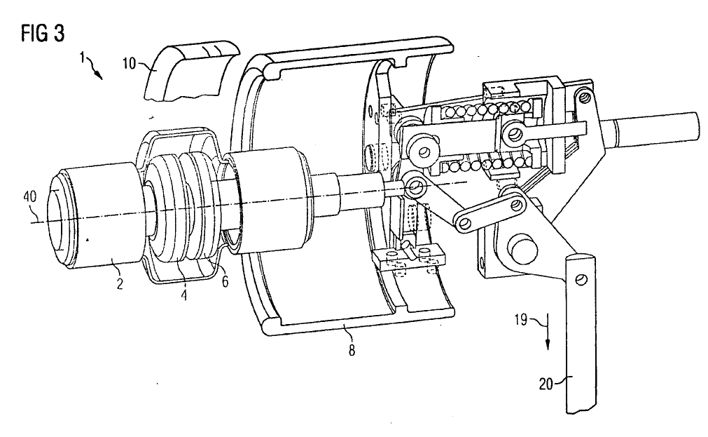

FIG. 3 shows, schematically, the circuit breaker illustrated in FIG. 1 in the open state;

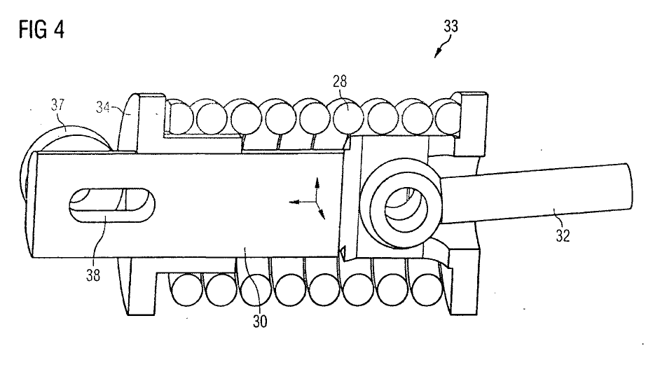

FIG. 4 shows, schematically, an exemplary embodiment of a contact-pressure spring energy store with a contact pressure spring.

FIG. 1 shows, schematically, an exemplary embodiment of a circuit breaker 1. The circuit breaker 1 has an arcing contact arrangement in the form of a vacuum interrupter 2 with a mating pole 4, which in this exemplary embodiment is arranged fixed, and a switching pole 6, which is capable of moving along a longitudinal axis 40. The circuit breaker 1 also has a rated current switch, which is connected electrically in parallel with the vacuum interrupter 2. The rated current switch comprises a rated current contact 8 and a rated current mating contact 10.

The rated current contact 8 is hollow-cylindrical. In the cavity enclosed in the form of a cylinder by the rated current contact 8, the vacuum interrupter 2 is arranged radially centrically, in a cross-sectional plane running perpendicular to the longitudinal axis 40, which vacuum interrupter 2 extends parallel to the longitudinal axis 40.

The switching pole 6 is designed to be movable along the longitudinal axis 40. The switching pole 6 and the mating pole 4 each have a switching face, which is provided for making electrical contact, the switching faces each being arranged perpendicular to the longitudinal axis 40 and planar-parallel with respect to one another. The switching pole 6 and the mating pole 4 are jointly surrounded by an evacuated space, which is enclosed by a vacuum housing 5.

The circuit breaker 1 has kinematics, which are connected at least indirectly to the switching pole 6 and at least indirectly to the rated current contact 8. The kinematics also have a switching lever 12 with an angled-off region, a central pivoting shaft 13 being arranged in the region of an apex of the angle thus formed, with the result that the switching lever 12 is capable of pivoting about the central pivoting shaft 13. A pivot axis formed by the pivoting shaft runs perpendicular to the longitudinal axis 40 of the circuit breaker. The central pivoting shaft 13 also passes through a fastening lug 15, which can be fastened movably on a housing at an end remote from the central pivoting shaft 13. The switching lever 12 is connected to a shaft 11 via the pivoting shaft 13, the shaft 11 extending parallel to the longitudinal axis 40. The pivoting shaft 13 passes through the shaft 11 in the region of a shaft end of the shaft 11, with the result that the shaft 11 is capable of pivoting about an axis formed by the pivoting shaft 13.

In the region of an aperture (not illustrated in this figure), the shaft 11 passes through a wall of the vacuum housing 5 and is connected to the switching pole 6 within the vacuum housing 5. The switching lever 12 is connected to the lug 14 on the force-input side in the region of one end via an articulated joint 16. The lug 14 is connected pivotably to an actuating element 18 in the region of an end remote from the articulated joint 16. The actuating element 18 is in the form of a substantially triangular plate, a switch shaft 22 being arranged perpendicular to a triangle plate plane in the region of a triangle apex, with the result that the triangle plate can be pivoted about the switch shaft 22. The actuating element 18 is connected movably to the lug 14 in the region of a triangle limb point. The actuating element 18 is connected to a switching rod 20 in the region of a triangle limb point, which is opposite the triangle limb point connected to the lug 14. The switching rod 20 can be driven, for example, by hydraulics, a spring energy store or kinematics or a comparable drive apparatus.

The switch shaft 22 is rigidly connected to a lever 24, the lever 24 extending perpendicular to the shaft axis of the switch shaft 22 and therefore being capable of being pivoted about the pivot axis formed by the switch shaft 22 on rotation of the switch shaft 22 by means of the actuating element 18.

The lever 24 is pivotably connected to a lug end of a lug 26 at an end remote from the switch shaft 22, the lug 26 being coupled in the region of an end, which is remote from the end pivotably connected to the lever 24, via a pivoting shaft 27 and via a connection piece to a rib 29, which is integrally formed on the rated current contact 8 and extends radially inwards, and therefore is effectively coupled to the rated current contact 8.

A pivot axis formed by the pivoting shaft 27 runs perpendicular to the longitudinal axis 40 of the circuit breaker 1.

During the movement of the switching rod 20, the rated current contact, driven via the actuating element 18, the lever 24 and the lug 26, can therefore be moved to and fro parallel to the longitudinal axis 40 of the circuit breaker 1.

The switching lever 12 is pivotably connected to an outer pivoting shaft 36, which is mounted on ball bearings in this exemplary embodiment, in the region of an end remote from the articulated joint 16. The pivoting shaft 36 is connected to a spring guide 30 and runs through a slot-shaped aperture of the spring guide 30. The spring guide 30 is arranged parallel to the longitudinal axis 40 and within a switching pressure spring 28, which is wound circumferentially around the spring guide 30.

The switching pressure spring 28 is secured in the region of its end facing the lever 12 by a spring disk 34, which is capable of moving along the spring guide. At its end remote from the first spring disk 34, it is secured by a second spring disk 35. The second spring disk 35 is connected to the spring guide 30 in such a way that it is capable of being displaced and fixed, whereas the spring disk 34 is arranged displaceably parallel to the longitudinal axis 40 on the spring guide 30.

In a region of the outer ends of the shaft 36, two wheels 37 are arranged, an end face of the first spring disk 34, driven by prestressing of the contact pressure spring 28, pressing against a circumferential point of the wheel 37 arranged on the shaft 36, which circumferential point faces the end face of the first spring disk 34. The spring force of the switching pressure spring 28 therefore acts perpendicular to the pivoting shaft 36.

The spring force of the switching pressure spring 28 therefore also acts via the switching lever 12 on the pivoting shaft 13, and therefore acts proportionally, in accordance with a force parallelogram, along the longitudinal axis 40 on the shaft 11 and perpendicular to a switching pole face of the switching pole 6. The switching pole 6 is operatively connected to the switching pressure spring 28 in this way.

In accordance with the above described force parallelogram, some of the spring force generated by the switching pressure spring 28 also tries to have a return effect on the actuating element 18 via the switching lever 12 and the lug 14. This return effect is prevented, however, by virtue of the fact that the pivot joint formed by the switching lever 12 and the lug 14 and the articulated joint 16 is bent back in the region of the pivot joint 16 and therefore cannot or can only partially have a return effect on the actuating element 18.

FIG. 2 shows a making operation of the circuit breaker 1 illustrated in FIG. 1.

The switching rod 20 can be moved in direction 21 so as to perform a making operation of the circuit breaker 1. The actuating element 18 pivots about the switch shaft 22 and moves the rated current contact 8 parallel to the longitudinal axis 40 via the lever 24, the lug 26 and the pivoting shaft 27. At the same time, during the making operation at the beginning of the described movement of the rated current contact 8, the switching pole 6 of the vacuum interrupter 2 is driven via the switch shaft 22, the lug 14, the lever 12 and the shaft 11. The shaft 11 and the switching pole 6, which is connected to the shaft 11, are therefore moved parallel to the longitudinal axis 40. The switching lever 12 is rotated about the outer pivoting shaft 36, which is mounted on ball bearings, during the making operation by means of the actuating element 18. If the switching rod 20 has approximately half an intended total excursion, the switching pole 6 of the vacuum interrupter 2 touches the mating contact 4, which is arranged fixed in position, of the vacuum interrupter 2. The vacuum interrupter 2 is now closed so as to be electrically conductive.

In the further course of a making movement brought about by the switching rod 20, the switching lever 12 is rotated about the central pivoting shaft 13. As a result of the force acting on the switching rod 20, the switching pressure spring 28 is now compressed via the pivoting shaft 36 and the spring disk 34 and therefore spring energy is stored in the switching pressure spring 28.

The mating pole 4 of the vacuum interrupter 2 and the switching pole 6 of the vacuum interrupter 2 are now pressed together both as a result of the spring force of the contact pressure spring 28 and as a result of the force acting via the switching rod 20, parallel to the longitudinal axis 40.

In the embodiment illustrated of the circuit breaker 1, the excursion of the switching pole 6 of the vacuum interrupter 2 is designed to be variable. For this purpose, the second spring disk 35 is connected to a switching rod, which extends parallel to the longitudinal axis 40, is in the form of an eye bolt 32 in the present exemplary embodiment and runs through an aperture of an elbow 31 arranged fixed in position. The eye bolt can be fixed via a fixing means, for example two fixing nuts (not illustrated in this figure) in terms of its position along the longitudinal axis 40. In order to fix it, the eye bolt 32, and therefore the position of the second spring disk 35, which is connected immovably to it in the axial direction, is fixed relative to the spring guide 30 by means of the two nuts, of which in case one is located on each side of the elbow.

If the eye bolt 32 is moved away from the spring disk 34 parallel to the longitudinal axis 40, the switching lever 12 is moved over the spring guide 30 and therefore the excursion of the switching pole 6 is extended.

FIG. 3 shows a breaking operation of the circuit breaker 1 shown in FIGS. 1 and 2.

A breaking operation of the circuit breaker 1 is brought about by a breaking movement of the switching rod 20 in the breaking direction 19. As a result, the rated current contact 8 experiences a breaking movement, while at the same time the compression spring 28 is relieved of tension as a result of a rotation of the lever 12 about the central pivoting shaft 13. In this phase, a breaking movement of the switching pole 6 does not yet take place. Only when the compression spring has been relieved of tension to a sufficient extend does the lever 12 begin to rotate about the outer pivoting shaft 36, with the result that a breaking movement of the switching pole 6 is brought about. During the breaking movement, isolation of the switching pole 6 from the mating pole 4 of the vacuum interrupter 2, driven by the actuating element 18, via the lug 14, the switching lever 12 and the shaft 11, is therefore brought about temporarily after isolation of the rated current contact 8 from the rated current mating contact 10.

Opening of the vacuum interrupter 2 is therefore brought about temporarily after opening of the rated current switch, formed by the rated current contact 8 and the rated current mating contact 10. In this case, only a section of the rated current mating contact 10 is illustrated. In an exemplary embodiment (not illustrated here), the rated current mating contact 10 is in the form of an annular sliding contact, which engages over the rated current contact 8.

FIG. 4 shows an exemplary embodiment of a contact-pressure spring energy store 33, formed by the contact pressure spring 28, the spring disk 34, the spring disk 25, the eye bolt 32 and the spring guide 30.

In the region of an end remote from the spring disk 35, the spring guide 30 has a slot 38 in the form of an aperture. In FIG. 1, the pivoting shaft 36 is passed through this slot 38.

Also illustrated is a wheel 36 with an aperture for passing through a shaft, the pivoting shaft 36 running through the aperture of said wheel. The wheel 37 is intended to be supported against the spring disk 34.

### LIST OF REFERENCE SYMBOLS

1 circuit breaker
2 vacuum interrupter
4 mating pole
5 vacuum housing
6 switching pole
8 rated current contact
10 rated current mating contact
11 shaft
12 switching lever
13 pivoting shaft
14 lug
15 fastening lug
16 articulated joint
18 actuating element
19 breaking direction
20 switching rod
21 making direction
22 switch shaft
24 lever
26 lug
27 pivoting shaft
28 switching pressure spring
29 groove
30 spring guide
31 elbow
32 eye bolt
33 contact-pressure spring energy store
34 spring disk
35 spring disk
36 bearing
37 wheel
38 slot

1-8. (canceled)

9. A circuit breaker, comprising:
a rated current contact arrangement having a rated current contact and a rated current mating contact movably mounted relative to one another;
an arcing contact arrangement having an arcing contact and an arcing mating contact movably disposed relative to one another; and
kinematics operatively connected to said rated current contact and said arcing contact, and an actuating element for driving said kinematics, said kinematics including:
a first lever connected, at least indirectly, to said actuating element, rotatably mounted about a switching fulcrum, and connected, at least indirectly, to said rated current contact for moving said rated current contact;
a second lever connected, at least indirectly, to said actuating element and rotatably mounted both about a first displaceable fulcrum and about a second displaceable fulcrum, said second lever being connected, at least indirectly, in the region of the first fulcrum to said arcing contact for moving said arcing contact by way of a displacement of the first fulcrum; and
a spring element, on which said second lever acts in the region of the second fulcrum during displacement, and which is configured to counteract a displacement of said second fulcrum with a predetermined force that is greater than a force required to displace said first fulcrum until contact is produced between said arcing contact and said arcing mating contact.

10. The circuit breaker according to claim 9, wherein said arcing contact arrangement is a vacuum interrupter with a switching pole forming said arcing contact and a mating pole forming said arcing mating contact.

11. The circuit breaker according to claim 10, wherein one or both of said switching pole and said rated current contact are in the form of an electrical impact contact.

12. The circuit breaker according to claim 11, wherein said first lever is a part of a first lever train, and said second lever is a part of a second lever train, said first and second lever trains each comprising said switching fulcrum as a fulcrum and being connected firstly to said actuating element and secondly to said rated current contact and said arcing contact, respectively, and wherein said first and second lever trains are matched to one another such that an excursion of said first lever train is greater than an excursion of said first fulcrum during a displacement thereof.

13. The circuit breaker according to claim 9, wherein said spring element is a compression spring disposed between said second lever at a region of the second fulcrum and an abutment.

14. The circuit breaker according to claim 13, which comprises a spring guide and a spring bearing capable of displacement with respect to said spring guide, wherein said spring bearing is disposed opposite said abutment and wherein said second lever acts on said spring bearing on occasion of a displacement of the second fulcrum and causes a tensioning of said spring, and wherein said abutment is capable of being displaced and fixed along said spring guide.

15. The circuit breaker according to claim 9, which comprises a lug connecting said actuating element and said second lever in articulated relationship.

16. The circuit breaker according to claim 9, wherein said rated current contact is shaped at least partially as a hollow cylinder, and said arcing contact arrangement is disposed at least partially within said rated current contact such that a switching movement of said rated current contact is effected coaxially with respect to a switching movement of said arcing contact of said arcing contact arrangement.

17. The circuit breaker according to claim 16, wherein said arcing contact arrangement is disposed radially centrically within said hollow cylinder of said rated current contact.
